(19) United States
(12) Patent Application Publication
(10) Pub. No.: US 2026/0134185 A1
(43) Pub. Date: May 14, 2026

(54) Adjustable-Order Fractional-Order Capacitor Circuit and Control Method Therefor

(71) Applicant: Guizhou Power Grid Co., Ltd., Guiyang (CN)

(72) Inventors: Yu WANG, Guiyang (CN); Bowen LI, Guiyang (CN); Tingyun GU, Guiyang (CN); Yumin HE, Guiyang (CN); Mingyong XIN, Guiyang (CN); Jianyang ZHU, Guiyang (CN); Changbao XU, Guiyang (CN); Chenghui LIN, Guiyang (CN); Li ZHANG, Guiyang (CN); Qihui FENG, Guiyang (CN); Houyi ZHANG, Guiyang (CN); Junyi MAO, Guiyang (CN); Bin LIU, Guiyang (CN); Qiji DAI, Guiyang (CN); Dunhui CHEN, Guiyang (CN); Yuanyuan ZHANG, Guiyang (CN)

(21) Appl. No.: 19/407,663

(22) Filed: Dec. 3, 2025

Related U.S. Application Data
(63) Continuation of application No. PCT/CN2024/115180, filed on Aug. 28, 2024.

(30) Foreign Application Priority Data
Dec. 27, 2023 (CN) 202311817258.6

(51) Int. Cl. G06F 30/367; G06F 119/06

(52) U.S. Cl. CPC G06F 30/367; G06F 2119/06

(57) ABSTRACT

The present invention discloses an adjustable-order fractional-order capacitor circuit and a control method therefor, including: using an improved fractional-order differential circuit; and using a junction field-effect transistor operating in a variable-resistance region to replace a fixed-value resistor in a common differential circuit, thereby achieving a fractional-order differential operation. In changing an order of the fractional-order circuit, an equivalent resistance of the junction field-effect transistor can be adaptively adjusted by the feedback tracking circuit to meet the order requirement. Without changing any element parameter in the differential circuit, an output signal of the differential circuit can lead an input signal in phase value by a value in an adjustable range, offering flexible adjustment.

### CROSS-REFERENCE TO RELATED APPLICATIONS

The present application is a continuation of International Application No. PCT/CN2024/115180, filed on Aug. 28, 2024, which claims priority to Chinese Patent Application No. 202311817258.6, filed on Dec. 27, 2023, the entire disclosure of which is incorporated herein by reference.

### TECHNICAL FIELD

The present invention relates to the technical field of control on adjustable-order fractional-order capacitor circuits, and in particular to an adjustable-order fractional-order capacitor circuit and a control method therefor.

### BACKGROUND

In classical circuit theory, ideal capacitors satisfying a volt-ampere characteristic of an integer-order calculus is widely used in analysis in the field of electrical engineering. However, in the real world, there is no integer-order capacitor which is only approximated by an integer order. Using the integer-order calculus to analyze a capacitor circuit inherently introduces inaccuracies. Therefore, applying a fractional-order calculus can more accurately describe a capacitor, and properties of a fractional-order capacitor can be utilized to improve circuit's performance, following discovery of new circuit's characteristics.

Currently, a common method for constituting a fractional-order capacitor circuit by using an operational amplifier mainly includes a GIC impedance converter circuit and a fractional-order differential phase-shift circuit, which achieves a circuit consisting of a resistor, a capacitor, an operational amplifier, and other devices. The above method has the following disadvantages: 1. if there is a need for changing an order of a fractional-order capacitor, it is necessary to replace a circuit element; and 2. a changed element parameter required for a corresponding order is sometimes difficult to find in reality.

### SUMMARY

An objective of the present part is to provide an overview for some aspects of the embodiments of the present invention and a brief description for some preferred embodiments. Some simplifications or omissions may be made in the present part as well as the abstract of the specification and the title of invention of the present application, so as not to obscure the objective of the present part as well as the abstract of the specification and the title of invention; however, such simplifications or omissions cannot be used for limiting the scope of the present invention.

In view of the existing problems mentioned above, the present invention is proposed.

Therefore, the present invention provides an adjustable-order fractional-order capacitor circuit and a control method therefor, capable of solving the problems proposed in Background.

To solve the above technical problems, the present invention provides the following technical solutions: an adjustable-order fractional-order capacitor circuit includes: resistor R, a fractional-order differential circuit, a feedback tracking circuit, and a subtractor circuit, where
an input terminal of the adjustable-order fractional-order capacitor circuit is connected to the ground at one end and to one terminal of resistor R at the other end, and the other terminal of resistor R is connected to an output terminal of the subtractor circuit;
the fractional-order differential circuit employs a junction field-effect transistor operating in a variable-resistance region to replace a fixed-value resistor in a common differential circuit, thereby achieving a differential operation;
an output of the feedback tracking circuit is applied to a gate terminal of the junction field-effect transistor in the fractional-order differential circuit, with a source terminal of the junction field-effect transistor grounded; the feedback tracking circuit controls an equivalent resistance value of the junction field-effect transistor in real time by controlling a gate-source voltage of the JFET, thereby achieving a fractional-order differential operation corresponding to a fractional order; by setting a digital reference comparison signal of a phase detector in the feedback tracking circuit, an expected fractional order is obtained; and
a voltage difference between an input voltage and an output voltage of the fractional-order differential circuit controls a voltage across resistor R, thereby controlling an input current across resistor R.

As a preferred solution of the adjustable-order fractional-order capacitor circuit of the present invention, the fractional-order differential circuit includes operational amplifier opa1, resistor R₁, resistor R₂, resistor R₃, resistor R₄, capacitor C₁, and a junction field-effect transistor (JFET), where the JFET operates in the variable-resistance region and is equivalent to a variable resistor R_{eq};
in a complex frequency domain, let \dot{v}ᵢₙ and \dot{i}ᵢₙ denote as an input voltage and an input current of the fractional-order capacitor circuit respectively,
then \dot{v}ᵢₙ and \dot{i}ᵢₙ satisfy the following characteristics of a fractional-order capacitor:

$${\text{?}}_{in} = {C}_{α} {s}^{α} {\text{?}}_{in}$$

$$\text{?} \text{indicates text missing or illegible when filed}$$

wherein s=jω represents a complex frequency, Cₐ is the fractional-order capacitance, and a is an order of the fractional-order capacitor, satisfying 0≤a≤2;
in the complex frequency domain, a voltage at a non-inverting input terminal of operational amplifier opa1 is denoted as \dot{v}₁₊, and a voltage at an inverting input terminal is denoted as \dot{v}₁₋; assuming that an input current of operational amplifier opa1 is equal to zero, the voltages at the non-inverting and inverting input terminals of operational amplifier opa1 in the fractional-order operational circuit are expressed as follows:

$${\text{?}}_{1 +} = \frac{j ω {R}_{eq} {C}_{1}}{1 + j ω {R}_{eq} {C}_{1}} {\text{?}}_{in}$$

$${\text{?}}_{1 -} = \frac{{R}_{2} {\text{?}}_{in} + {R}_{1} {\text{?}}_{a}}{{R}_{1} + {R}_{2}}$$

$$\text{?} \text{indicates text missing or illegible when filed}$$

and assuming that a differential input voltage of operational amplifier opa1 is equal to zero, and R₁=R₂, then the following equation is obtained:

$$\frac{{\text{?}}_{a}}{{\text{?}}_{in}} = a + bj = \frac{{ω}^{2} {R}_{eq}^{2} {C}_{1}^{2} - 1 + j2 ω {R}_{eq} {C}_{1}}{1 + {ω}^{2} {R}_{3}^{2} {C}_{1}^{2}}$$

$$a = \frac{ω {R}_{eq}^{2} {C}_{1}^{2} - 1}{1 + {ω}^{2} {R}_{eq}^{2} {C}_{1}^{2}}$$

$$b = \frac{2 ω {R}_{eq} {C}_{1}}{1 + {ω}^{2} {R}_{eq}^{2} {C}_{1}^{2}}$$

$$\text{?} \text{indicates text missing or illegible when filed}$$

wherein R_{eq} represents an equivalent resistance value of the junction field-effect transistor (JFET), \dot{v}ₐ represents an output voltage of the fractional-order differential circuit, \dot{v}ᵢₙ represents an input voltage of the fractional-order differential circuit, C₁ represents a capacitance value, a is a real part, and b is an imaginary part.

As a preferred solution of the adjustable-order fractional-order capacitor circuit of the present invention, the fractional-order differential circuit further includes:
assuming that the output voltage \dot{v}ₐ and an input voltage \dot{v}ᵢₙ of the fractional-order differential circuit satisfy the following fractional-order differential relationship:

$${\text{?}}_{a} = {kj}^{α} {\text{?}}_{in} = k {\text{?}}_{in} ( cos \frac{απ}{2} + j sin \frac{απ}{2} )$$

$$\text{?} \text{indicates text missing or illegible when filed}$$

wherein a coefficient k is a gain of the fractional-order differential circuit, a is a fractional order, and 0<a<2 in the fractional-order capacitor circuit;
the following result is obtained according to a correspondence between the real part and the imaginary part:

$$\frac{2 ω {R}_{eq} {C}_{1}}{ω {R}_{eq}^{2} {C}_{1}^{2} - 1} = tan \frac{απ}{2}$$

wherein the output voltage \dot{v}ₐ of the fractional-order differential circuit leads the input voltage \dot{v}ᵢₙ of the fractional-order differential circuit in a phase by aπ/2.

As a preferred solution of the adjustable-order fractional-order capacitor circuit of the present invention, the fractional-order differential circuit further includes:
additional resistors R₃ and R₄ are introduced in the circuit to reduce nonlinearity of an equivalent resistance of the JFET by means of circuit compensation, and an output current i_{D} of the JFET is related to a gate-source voltage v_{GS} and a drain-source voltage v_{DS} as follows:

$${i}_{D} = K ( {v}_{GS} - {v}_{T} - \frac{{v}_{DS}}{2} ) {v}_{DS}$$

wherein K is a constant corresponding to each field-effect transistor, v_{T} is an approximate threshold voltage, and the equivalent resistance R_{DS} of the JFET is:

$${R}_{DS} = \frac{\partial {i}_{D}}{\partial {v}_{DS}} = \frac{1}{K ( {v}_{GS} - {v}_{T} - \frac{{v}_{DS}}{2} )}$$

wherein a value of the equivalent resistance R_{DS} of the JFET is equal to that pf a variable resistance R_{eq}, i.e., R_{DS}=R_{eq}.

As a preferred solution of the adjustable-order fractional-order capacitor circuit of the present invention, the fractional-order differential circuit further includes:
resistors R₃ and R₄ are used to suppress an effect of v_{DS} on i_{D} through negative feedback of v_{DS}, and the gate-source voltage v_{GS} of the JFET satisfies the following relationship with a feedback voltage v_{fd} and drain-source voltage v_{DS}:

$${v}_{GS} = \frac{{R}_{4} {v}_{fd}}{{R}_{3} + {R}_{4}} + \frac{{R}_{3} {v}_{DS}}{{R}_{3} + {R}_{4}}$$

assuming that values of resistances satisfies R₃=R₄, the following equation is derived:

$${v}_{GS} = \frac{{v}_{fd}}{2} + \frac{{v}_{DS}}{2}$$

and the following equation is obtained according to an expression of the equivalent resistance of the JFET:

$${i}_{D} = K [ {v}_{GS} - {v}_{T} - \frac{{v}_{DS}}{2} ] {v}_{DS} = K ( \frac{{v}_{fd}}{2} - {v}_{T} ) {v}_{DS} \\ {R}_{DS} = \frac{\partial {i}_{D}}{\partial {v}_{DS}} = \frac{1}{K ( \frac{{v}_{fd}}{2} - {v}_{T} )}$$

wherein K is the constant corresponding to each field-effect transistor, and v_{T} is the approximate threshold voltage.

As a preferred solution of the adjustable-order fractional-order capacitor circuit of the present invention, the feedback tracking circuit includes: a phase detector, an RC low-pass filter, an integrator, and a voltage follower, where
the phase detector comprises a multiplier and a subtractor;
the RC low-pass filter consists of capacitor C₂ and resistor R₉;
the integrator consists of operational amplifier opa2, resistor R₁₀, resistor R₁₁, and capacitor C₃; and
the voltage follower consists of operational amplifier opa3, resistor R₁₂, and resistor R₁₃;
As a preferred solution of the adjustable-order fractional-order capacitor circuit of the present invention, the subtractor circuit includes: operational amplifier opa4, resistor R₅, resistor R₆, resistor R₇, and resistor R₈, where
in the complex frequency domain, a voltage at a non-inverting input terminal of operational amplifier opa4 is \dot{v}₂₊ and a voltage at an inverting input terminal is \dot{v}₂₋; assuming that an input current of operational amplifier opa4 is equal to zero, the following equation is obtained:

$${\dot{v}}_{2 +} = \frac{{R}_{8}}{{R}_{7} + {R}_{8}} {\dot{v}}_{in} \\ {\dot{v}}_{2 -} = \frac{{R}_{5} {\dot{v}}_{o} + {R}_{6} {\dot{v}}_{a}}{{R}_{5} + {R}_{6}}$$

assuming that a differential input voltage of operational amplifier opa4 is equal to zero, and R₅=R₆=R₇=R₈, then the following equation is obtained:

$${\dot{v}}_{o} = {\dot{v}}_{a} - {\dot{v}}_{in}$$

an output voltage of the subtractor is given by the following equation:

$${\dot{v}}_{o} = {\dot{v}}_{in} - \frac{1}{{ω}^{α}} {( j ω )}^{α} {\dot{v}}_{in}$$

according to Kirchhoff s voltage law, the voltage across resistor R is:

$${\dot{v}}_{R} = {\dot{v}}_{in} - ( {\dot{v}}_{in} - \frac{1}{{ω}^{α}} {( j ω )}^{α} {\dot{v}}_{in} ) = \frac{1}{{ω}^{α}} {( j ω )}^{α} {\dot{v}}_{in}$$

and then a current flowing through resistor R, i.e., the input current, is:

$${\dot{i}}_{in} = \frac{1}{{ω}^{α} R} {( j ω )}^{α} {\dot{v}}_{in} = {C}_{α} {s}^{α} {\dot{v}}_{in}$$

wherein a capacitance value of the fractional-order capacitor is C_{α}=1/ω^{α}R, and \dot{v}₀ represents an output voltage of the subtractor.

A method for controlling an adjustable-order fractional-order capacitor circuit includes:
setting an order of the fractional-order capacitor circuit as required by a system, and designing a set circuit consisting of a resistor, a fractional-order differential circuit, a feedback tracking circuit, and a subtractor circuit according to the order of the fractional-order capacitor circuit;
using the fractional-order differential circuit for a differentiation operation, applying an output of the feedback tracking circuit to the fractional-order differential circuit, achieving a fractional-order differentiation operation by the feedback tracking circuit controlling an internal voltage, and obtaining an expected fractional order by setting a digital reference comparison signal of a phase detector in the feedback tracking circuit; and
controlling an input current across the adjustable-order fractional-order capacitor circuit by controlling a voltage across resistor R according to a voltage difference between an input voltage and an output voltage of the fractional-order differential circuit.

A computer device includes a memory in which a computer program is stored and a processor, where when the computer program is executed by the processor, the steps of the above method are implemented.

A computer-readable storage medium in which a computer program is stored, where when the computer program is executed by a processor, the steps of the above method are implemented.

The present invention has the following beneficial effects: the present invention provides an adjustable-order fractional-order capacitor circuit and a control method therefor, in which an improved fractional-order differential circuit is used, and the junction field-effect transistor (JFET) operating in the variable-resistance region is used to replace the fixed-value resistor in the common differential circuit, thereby achieving the fractional-order differential operation. In changing the order of the fractional-order circuit, the equivalent resistance of the JFET can be adaptively adjusted by the feedback tracking circuit to meet the order requirement. Without changing any element parameter in the differential circuit, an output signal of the differential circuit can lead an input signal in phase value by a value in an adjustable range, offering flexible adjustment.

### BRIEF DESCRIPTION OF DRAWINGS

In order to describe the technical solutions in the embodiments of the present invention more clearly, the following briefly introduces the accompanying drawings required for describing the embodiments. Apparently, the accompanying drawings in the following description show only some embodiments of the present invention, and those of ordinary skill in the art may still derive other drawings from these drawings without any creative efforts. In the drawings:

FIG. 1 is an adjustable-order fractional-order capacitor circuit model diagram of an adjustable-order fractional-order capacitor circuit and a control method therefor provided by one embodiment of the present invention;

FIG. 2 is an adjustable-order fractional-order capacitor simulation principle diagram of an adjustable-order fractional-order capacitor in an adjustable-order fractional-order capacitor circuit and a control method therefor provided by one embodiment of the present invention;

FIG. 3 is a simulation diagram of a current and a voltage across a fractional-order capacitor with an operating frequency of 10 kHz and an order of 0.5 in an adjustable-order fractional-order capacitor circuit and a control method therefor provided by one embodiment of the present invention;

FIG. 4 is a simulation diagram of a current and a voltage across a fractional-order capacitor with an operating frequency of 10 kHz and an order of 1 in an adjustable-order fractional-order capacitor circuit and a control method therefor provided by one embodiment of the present invention;

FIG. 5 is a simulation diagram of a current and a voltage across a fractional-order capacitor with an operating frequency of 10 kHz and an order of 1.5 in an adjustable-order fractional-order capacitor circuit and a control method therefor provided by one embodiment of the present invention;

FIG. 6 is an internal structure diagram of a computer device in an adjustable-order fractional-order capacitor circuit and a control method therefor provided by one embodiment of the present invention.

### DETAILED DESCRIPTION OF THE EMBODIMENTS

In order to make the aforementioned purposes, features and advantages of the present invention more apparent and comprehensible, detailed descriptions of specific implementations of the present invention are provided below in conjunction with the appended drawings. Apparently, the described embodiments are merely a part of the embodiments of the present invention, rather than all embodiments. On the basis of the examples of the present invention, all other examples obtained by those of ordinary skill in the art without creative efforts shall fall within the protection scope of the present invention.

A number of specific details are set forth in the description below to provide a thorough understanding for the present invention, however, the present invention may also be implemented in other manners different from those described herein, and those skilled in the art may make similar generalization without departing from the essence of the present invention, therefore, the present invention is not limited by the specific examples disclosed below.

Secondly, the term “one embodiment” or “embodiments” referred herein refers to specific features, structures, or characteristics that may be incorporated into at least one realization manner of the present invention. The term “in one example” appearing at different positions in the present specification does not necessarily refer to the same example, nor is it a separate or selective example that is mutually exclusive to other examples.

The present invention is described in detail in conjunction with schematic diagrams. For the purpose of description, sectional views of the device structure are partially enlarged without being drawn to scale. The schematic diagrams are merely exemplary and should not limit the protection scope of the present invention. Furthermore, it is important to consider the three-dimensional spatial dimensions of length, width, and depth in actual production.

It should be noted that in the description of the present invention that terms such as “up, down, inside, and outside” indicating orientation or positional relationships are based on the orientation or positional relationships shown in the illustrations for the purpose of facilitating the description and simplifying the disclosure. They do not indicate or imply that the device or the components referred to must have a specific orientation, be constructed in a specific orientation, or operate in a specific orientation, and therefore should not be construed as limiting the present invention. Moreover, terms like “first, second or third” are only used for description, and should not be considered as a designation or designation of relative importance.

Unless otherwise explicitly specified and limited in the present invention, the terms “installation, connection, and linking” should be understood in a broad sense. For example, they could refer to fixed or detachable connections, as well as integrally formed connections. They could also encompass mechanical, electrical or direct connections, indirect connections via intermediaries, and connections within two components. The terms described above have specific meanings in the present invention that can be understood by those skilled in the art in light of the particular circumstances.

### Embodiment 1

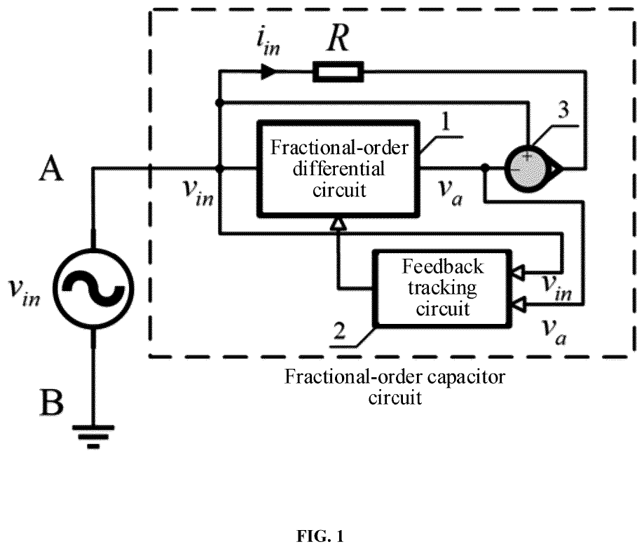

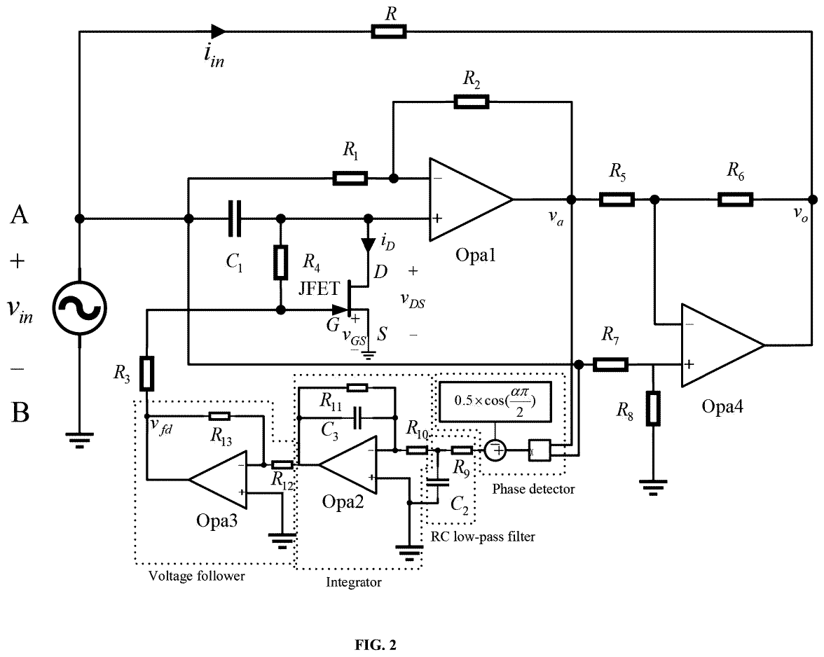

Referring to FIGS. 1-6, they show a first embodiment of the present invention. This embodiment provides an adjustable-order fractional-order capacitor circuit and a control method therefor, where the adjustable-order fractional-order capacitor circuit includes: resistor R, a fractional-order differential circuit, a feedback tracking circuit, and a subtractor circuit.

An input terminal of the adjustable-order fractional-order capacitor circuit is connected to the ground at one end and to one terminal of resistor R at the other end; and the other terminal of resistor R is connected to an output terminal of the subtractor circuit.

The fractional-order differential circuit employs a junction field-effect transistor operating in a variable-resistance region to replace a fixed-value resistor in a common differential circuit, thereby achieving a differential operation.

An output of the feedback tracking circuit is applied to a gate terminal of the junction field-effect transistor in the fractional-order differential circuit, with a source terminal of the junction field-effect transistor grounded; the feedback tracking circuit controls an equivalent resistance value of the junction field-effect transistor in real time by controlling a gate-source voltage of the JFET, thereby achieving a fractional-order differential operation corresponding to a fractional order; and by setting a digital reference comparison signal of a phase detector in the feedback tracking circuit, an expected fractional order is obtained.

a voltage difference between an input voltage and an output voltage of the fractional-order differential circuit controls a voltage across resistor R, thereby controlling an input current across resistor R.

It should be noted that the fractional-order differential circuit includes operational amplifier opa1, resistor R₁, resistor R₂, resistor R₃, resistor R₄, capacitor C₁, and a junction field-effect transistor (JFET), where the JFET operates in the variable-resistance region and is equivalent to a variable resistor R_{eq}.

More further, in a complex frequency domain, let \dot{v}ᵢₙ and \dot{i}ᵢₙ denote as an input voltage and an input current of the fractional-order capacitor circuit respectively,
then \dot{v}ᵢₙ and \dot{i}ᵢₙ satisfy the following characteristics of a fractional-order capacitor:

$${\dot{i}}_{in} = {C}_{α} {s}^{α} {\dot{v}}_{in} \qquad ( 1 )$$

wherein s=jω represents a complex frequency, Cₐ is the fractional-order capacitance, and a is an order of the fractional-order capacitor, satisfying 0≤a≤2;

More further, in the complex frequency domain, a voltage at a non-inverting input terminal of operational amplifier opa1 is denoted as \dot{v}₁₊, and a voltage at an inverting input terminal is denoted as \dot{v}₁₋; and assuming that an input current of operational amplifier opa1 is equal to zero, the voltages at the non-inverting and inverting input terminals of operational amplifier opa1 in the fractional-order operational circuit are expressed as follows:

$${\dot{v}}_{1 +} = \frac{j ω {R}_{eq} {C}_{1}}{1 + j ω {R}_{eq} {C}_{1}} {\dot{v}}_{in} \qquad ( 2 )$$

$${\dot{v}}_{1 -} = \frac{{R}_{2} {\dot{v}}_{in} + {R}_{1} {\dot{v}}_{a}}{{R}_{1} + {R}_{2}} \qquad ( 3 )$$

More further, assuming that a differential input voltage of operational amplifier opa1 is equal to zero, and R₁=R₂, then the following equation is obtained:

$$\frac{{\dot{v}}_{a}}{{\dot{v}}_{in}} = a + bj = \frac{{ω}^{2} {R}_{eq}^{2} {C}_{1}^{2} - 1 + j 2 ω {R}_{eq} {C}_{1}}{1 + {ω}^{2} {R}_{3}^{2} {C}_{1}^{2}} \qquad ( 4 )$$

$$a = \frac{ω {R}_{eq}^{2} {C}_{1}^{2} - 1}{1 + {ω}^{2} {R}_{eq}^{2} {C}_{1}^{2}} \qquad ( 5 )$$

$$b = \frac{2 ω {R}_{eq} {C}_{1}}{1 + {ω}^{2} {R}_{eq}^{2} {C}_{1}^{2}} \qquad ( 6 )$$

wherein R_{eq} represents an equivalent resistance value of the junction field-effect transistor (JFET), \dot{v}ₐ represents an output voltage of the fractional-order differential circuit, \dot{v}ᵢₙ represents an input voltage of the fractional-order differential circuit, C₁ represents a capacitance value, a is a real part, and b is an imaginary part.

It should be noted that it is assumed that the input current of operational amplifier opa1 is equal to zero, because, for an ideal operational amplifier, the input current is equal to zero, that is, a “virtual open-circuit” condition is considered; and it is assumed that a differential mode input voltage of operational amplifier opa1 is equal to zero, because, for the ideal operational amplifier, the differential-mode input voltage is equal to zero, that is, a “virtual short-circuit” condition is considered.

More further, the fractional-order differential circuit further includes:
assuming that the output voltage \dot{v}ₐ and an input voltage \dot{v}ᵢₙ of the fractional-order differential circuit satisfy the following fractional-order differential relationship:

$${\dot{v}}_{a} = {kj}^{α} {\dot{v}}_{in} = k {\dot{v}}_{in} ( cos \frac{α π}{2} + j sin \frac{α π}{2} ) \qquad ( 7 )$$

wherein a coefficient k is a gain of the fractional-order differential circuit, a is a fractional order, and 0<a<2 in the fractional-order capacitor circuit;
the following result is obtained according to a correspondence between the real part and the imaginary part:

$$\frac{2 ω {R}_{eq} {C}_{1}}{ω {R}_{eq}^{2} {C}_{1}^{2} - 1} = tan \frac{α π}{2} \qquad ( 8 )$$

wherein the output voltage \dot{v}ₐ of the fractional-order differential circuit leads the input voltage \dot{v}ᵢₙ of the fractional-order differential circuit in a phase by aπ/2.

It should be noted that according to the correspondence between the real part and the imaginary part, various element's values in the fractional-order differential circuit satisfy the condition that the equation (5) is equal to

$$cos \frac{α π}{2}$$

in the equation (7), and the equation (6) is equal to

$$sin \frac{α π}{2}$$

in the equation (7).

More further, the fractional-order differential circuit further includes:
additional resistors R₃ and R₄ are introduced in the circuit to reduce nonlinearity of an equivalent resistance of the JFET by means of circuit compensation, and an output current i_{D} of the JFET is related to a gate-source voltage v_{GS} and a drain-source voltage v_{DS} as follows:

$${i}_{D} = K ( {v}_{G S} - {v}_{T} - \frac{{v}_{D S}}{2} ) {v}_{D S} \qquad ( 9 )$$

wherein K is a constant corresponding to each field-effect transistor, v_{T} is an approximate threshold voltage, and the equivalent resistance R_{DS} of the JFET is:

$${R}_{DS} = \frac{\partial {i}_{D}}{\partial {v}_{DS}} = \frac{1}{K ( {v}_{GS} - {v}_{T} - \frac{{v}_{DS}}{2} )} \qquad ( 10 )$$

wherein a value of the equivalent resistance R_{DS} of the JFET is equal to that pf a variable resistance R_{eq}, i.e., R_{DS}=R_{eq}.

More further, the fractional-order differential circuit further includes:

It can be seen from the equation (10), the equivalent resistance of the JFET is related to v_{DS} in addition to being controlled by v_{GS}, which results in nonlinearity of the equivalent resistance value. Resistors R₃ and R₄ are used to suppress an effect of v_{DS} on i_{D} through negative feedback of v_{DS}, and the gate-source voltage v_{GS} of the JFET satisfies the following relationship with a feedback voltage v_{fd} and drain-source voltage v_{DS}:

$${ν}_{G S} = \frac{{R}_{4} {v}_{fd}}{{R}_{3} + {R}_{4}} + \frac{{R}_{3} {v}_{DS}}{{R}_{3} + {R}_{4}} \qquad ( 11 )$$

assuming that values of resistances satisfies R₃=R₄, the following equation is derived:

$${v}_{GS} = \frac{{v}_{fd}}{2} + \frac{{v}_{DS}}{2} \qquad ( 12 )$$

and the following equation is obtained according to an expression of the equivalent resistance of the JFET:

$${i}_{D} = K [ {v}_{GS} - {v}_{T} - \frac{{v}_{DS}}{2} ] {v}_{D S} = K ( \frac{{v}_{fd}}{2} - {v}_{T} ) {v}_{D S} \qquad ( 13 )$$

$${R}_{DS} = \frac{\partial {i}_{D}}{\partial {v}_{DS}} = \frac{1}{K ( \frac{{v}_{fd}}{2} - {v}_{T} )} \qquad ( 14 )$$

wherein K is the constant corresponding to each field-effect transistor, and v_{T} is the approximate threshold voltage.

More further, it can be seen from the equation (14), the equivalent resistance of the JFET, subsequent to introduction of negative feedback, is independent of v_{DS}, and a nonlinear effect of v_{DS} on the equivalent resistance of the JFET is greatly weakened.

It should be noted that the feedback tracking circuit includes: a phase detector, an RC low-pass filter, an integrator a voltage follower, where
the phase detector includes a multiplier and a subtractor;
the RC low-pass filter consists of capacitor C₂ and resistor R₉;
the integrator consists of operational amplifier opa2, resistor R₁₀, resistor R₁₁, and capacitor C₃; and
the voltage follower consists of operational amplifier opa3, resistor R₁₂, resistor R₁₃.

More further, from the equation (4), it can be seen that a gain of the fractional-order differential circuit is 1. Therefore, amplitudes of the input and output signals of the fractional-order differential circuit remain equal, i.e., \dot{v}ₐ=j^{α}\dot{v}ᵢₙ.

More further, let the input signal of the fractional-order differential circuit be vᵢₙ=A sin(ωt+pᵢ), the output signal be vₐ=A sin(ωt+pₒ), and the two signals be multiplied, the phase detector multiplies vᵢₙ and vₐ, with a calculation result being:

$$A sin ( ω t + {P}_{i} ) \cdot A sin ( ω t + {P}_{o} ) = \frac{1}{2} {A}^{2} [ cos ( {P}_{o} - {P}_{i} ) - cos ( {P}_{o} + {P}_{i} ) cos ( 2 ω t ) + sin ( {P}_{o} + {P}_{i} ) sin ( 2 ω t ) ] \qquad ( 15 )$$

It should be noted that a product of the above two contains a second harmonic component and a DC component. To make the output voltage vₐ of the fractional-order differential circuit satisfy the given relationship in the equation (7) with the input voltage vᵢₙ, a phase difference between vₐ and vᵢₙ, should satisfy

$${p}_{o} - {p}_{i} = \frac{απ}{2}$$

Then, a DC component reference comparison value should be set as

$$\frac{1}{2} {A}^{2} cos \frac{α π}{2}$$

to determine the order of the fractional-order capacitor circuit as a. From comparison on the DC component obtained by multiplying vₐ and vᵢₙ with an expected DC component reference value in real time, an error between a current phase difference and an expected phase difference is obtained. The DC component error is extracted using the RC low-pass filter, and then integrated with the integrator. If the error is not eliminated, a regulation effect is continuously enhanced. The output voltage, isolated by the voltage follower, is applied to the gate terminal of the JFET, followed by dynamically changing the equivalent resistance value of the JFET in real time to satisfy the equation (8), ensuring the output voltage vₐ of the fractional-order differential circuit to lead the input voltage vᵢₙ in phase by an expected value aπ/2.

More further, the subtractor circuit includes: operational amplifier opa4, resistor R₅, resistor R₆, resistor R₇, and resistor R₈.

More further, in the complex frequency domain, a voltage at a non-inverting input terminal of operational amplifier opa4 is \dot{v}₂₊, and a voltage at an inverting input terminal is \dot{v}₂₋; and assuming that an input current of operational amplifier opa4 is equal to zero, the following equation is obtained:

$${\dot{v}}_{2 +} = \frac{{R}_{8}}{{R}_{7} + {R}_{8}} {\dot{v}}_{i n} \qquad ( 16 )$$

$${\dot{v}}_{2 -} = \frac{{R}_{5} {\dot{v}}_{o} + {R}_{6} {\dot{v}}_{a}}{{R}_{5} + {R}_{6}} {\dot{v}}_{i n} \qquad ( 17 )$$

More further, assuming that a differential input voltage of operational amplifier opa4 is equal to zero, and R₅=R₆=R₇=R₈, then the following equation is obtained:

$${\dot{v}}_{o} = {\dot{v}}_{a} - {\dot{v}}_{i n} \qquad ( 18 )$$

More further, an output voltage of the subtractor is given by the following equation:

$${\dot{v}}_{o} = {\dot{v}}_{i n} - \frac{1}{{ω}^{α}} {( j ω )}^{α} {\dot{v}}_{i n} \qquad ( 19 )$$

More further, according to Kirchhoffs voltage law, the voltage across resistor R is:

$${\dot{v}}_{R} = {\dot{v}}_{i n} - ( {\dot{v}}_{i n} - \frac{1}{{ω}^{α}} {( j ω )}^{α} {\dot{v}}_{i n} ) = \frac{1}{{ω}^{α}} {( j ω )}^{α} {\dot{v}}_{i n} \qquad ( 20 )$$

More further, a current flowing through resistor R, i.e., the input current, is:

$${\dot{i}}_{i n} = \frac{1}{{ω}^{α} R} {( j ω )}^{α} {\dot{v}}_{i n} = {C}_{α} {s}^{α} {\dot{v}}_{i n} \qquad ( 21 )$$

wherein a capacitance value of the fractional-order capacitor is C_{α}=1/ω^{α}R, and \dot{v}ₒ represents an output voltage of the subtractor.

It should be noted that it can be seen from the equations (21), the circuit consisting of the fractional-order differential circuit, the feedback tracking circuit, the subtractor circuit, and resistor R conforms to a definition of the fractional-order capacitor.

Each of the above unit modules may be embedded in or independent of a processor in a computer device in a hardware form, or may be stored in a memory in the computer device in a software form, so that the processor calls operations corresponding to the above modules.

In a preferred embodiment, a method for controlling an adjustable-order fractional-order capacitor circuit includes:
setting an order of the fractional-order capacitor circuit as required by a system, and designing a set circuit consisting of a resistor, a fractional-order differential circuit, a feedback tracking circuit, and a subtractor circuit according to the order of the fractional-order capacitor circuit;
using the fractional-order differential circuit for a differential operation, applying an output of the feedback tracking circuit to the fractional-order differential circuit, achieving a fractional-order differential operation by the feedback tracking circuit controlling an internal voltage, and obtaining an expected fractional order by setting a digital reference comparison signal of a phase detector in the feedback tracking circuit; and
controlling an input current across the adjustable-order fractional-order capacitor circuit by controlling a voltage across resistor R according to a voltage difference between an input voltage and an output voltage of the fractional-order differential circuit.

In one embodiment, provided is a computer device, which may be a terminal, and its internal structural diagram may be shown in FIG. 6. The computer device includes a processor, a memory, a communication interface, a display screen, and an input apparatus which are connected by means of a system bus. The processor of the computer device is used for providing calculation and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The communication interface of the computer device is configured to communicate with an external terminal in a wired or wireless manner, and the wireless manner may be implemented by using WIFI, a mobile cellular network, near field communication (NFC), or other technologies. The computer program is executed by the process to implement the method for controlling the adjustable-order fractional-order capacitor circuit. The display screen of the computer device may be a liquid crystal display screen or an electronic ink display screen, and the input apparatus of the computer device may be a touch layer covered on the display screen, or may be a button, a trackball, or a touchpad arranged on a shell of the computer device, or may be an external keyboard, touchpad or mouse.

In one embodiment, provided is a computer-readable storage medium, with computer programs stored thereon. The computer program, when executed by the processor, implements the following steps:
setting an order of the fractional-order capacitor circuit as required by a system, and designing a set circuit consisting of a resistor, a fractional-order differential circuit, a feedback tracking circuit, and a subtractor circuit according to the order of the fractional-order capacitor circuit;
using the fractional-order differential circuit for a differential operation, applying an output of the feedback tracking circuit to the fractional-order differential circuit, achieving a fractional-order differential operation by the feedback tracking circuit controlling an internal voltage, and obtaining an expected fractional order by setting a digital reference comparison signal of a phase detector in the feedback tracking circuit; and
controlling an input current across the adjustable-order fractional-order capacitor circuit by controlling a voltage across resistor R according to a voltage difference between an input voltage and an output voltage of the fractional-order differential circuit.

### Embodiment 2

Referring to FIGS. 1-5, they show an embodiment of the present invention. This embodiment provides an adjustable-order fractional-order capacitor circuit and a control method therefor. In order to verify the beneficial effects of the present invention, scientific demonstration is performed through an experiment.

Through simulation demonstration on this embodiment, various element's parameters are as follows:
According to the equation (15), assuming that a digital reference comparison signal in the feedback tracking circuit is set as 0.5 cos(aπ/2), the order of the fractional-order capacitor circuit is set as a=0.5, and the input voltage viₙ, is taken to be 1 V/10 kHz, this model is demonstrated, that is, vᵢₙ=Vᵢₙ sin 2πft where Vᵢₙ=1V, and f=10 kHz. Remaining circuit's parameters are set as follows: a resistance is set as R=2Ω, capacitances are set as C₁=1 nF, C₂=10 μF, and C₃=1.2 nF. In addition, the following parameters are set as: R₁=R₂=4.3kΩ, R₃=R₄=47 kΩ, R₅=R₆=R₇=R₈=R₉=10 kΩ, R₁₀=4 kΩ, R₁₁=10 MΩ, and R₁₂=R₁₃=10 kΩ. Substituting the above parameters into the equation (21) yields a time-domain expression for a fractional-order capacitor current as:

$${i}_{i n} = {C}_{α} {s}^{α} {v}_{i n} = \frac{1}{{ω}^{α} R} {ω}^{α} sin ( 2 π f t + \frac{απ}{2} ) = \frac{1}{2} sin ( 2 π f t + \frac{α π}{2} ) \qquad ( 22 )$$

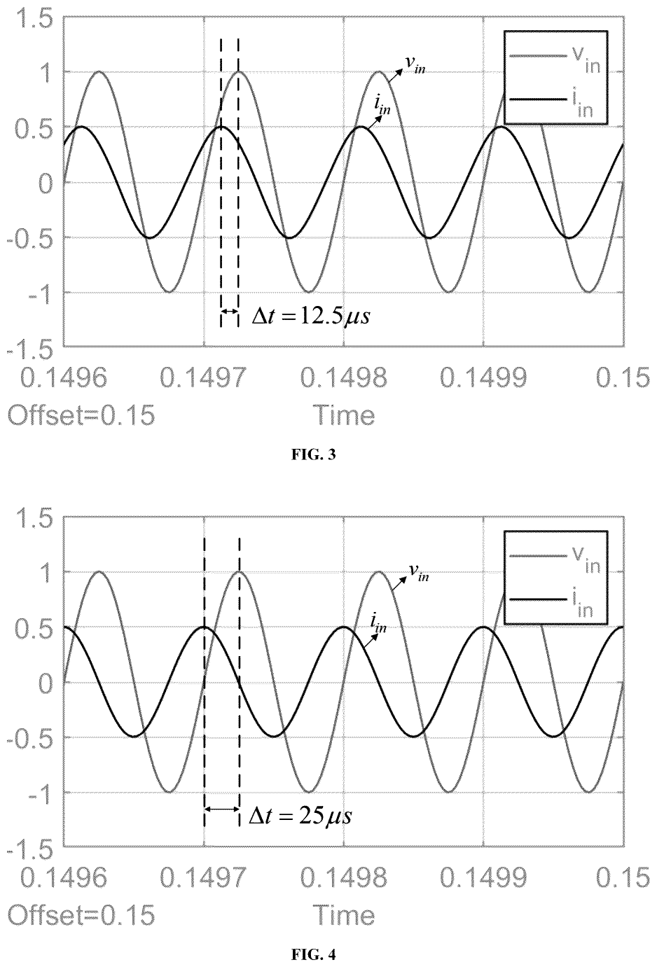

A simulation waveform of the circuit is shown in FIG. 3. A simulation result in FIG. 3 shows that the current peak is 0.5 A, with the current leading the voltage by (12.5×10⁻⁶)×10000×360°=45°=0.257c, which is consistent with the equation (22).

According to the equation (15), assuming that the digital reference comparison signal in the feedback tracking circuit is set as 0.5 cos(απ/2), the order of the fractional-order capacitor circuit is set as a=1, and the input voltage vᵢₙ=Vᵢₙ sin 2πft is still taken, where Vᵢₙ=1V, an AC current with f=10 kHz used for demonstrating this model, and the remaining circuit's parameters are invariable.

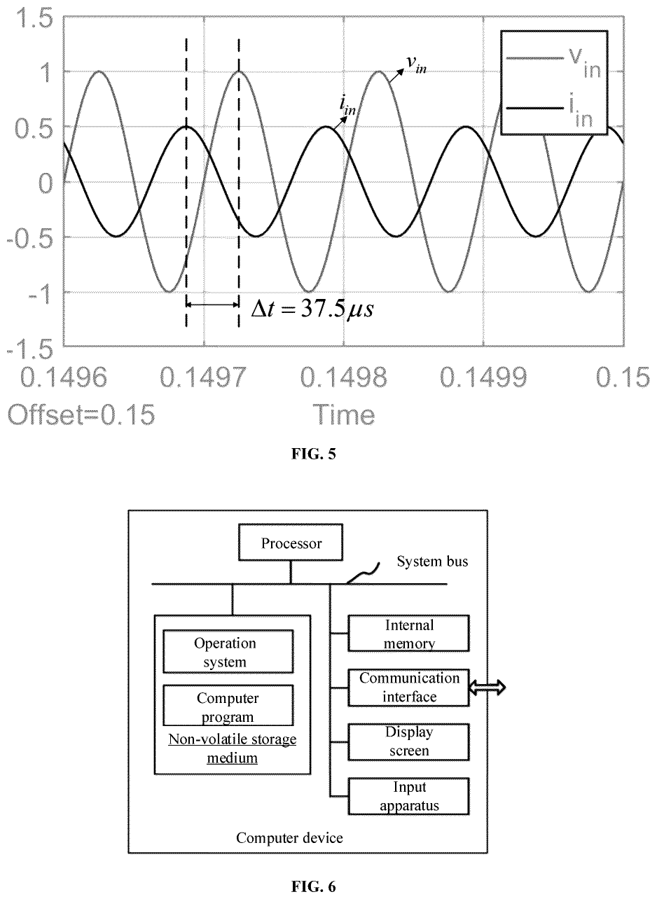

A simulation waveform of the circuit is shown in FIG. 4. A simulation result in FIG. 5 shows that the current peak is 1 A, with the current leading the voltage by (25×10⁻⁶)×10000×360°=90°=0.5π, which is consistent with a theoretical analysis result.

According to the equation (15), assuming that the digital reference comparison signal in the feedback tracking circuit is set as 0.5 cos(aπ/2), the order of the fractional-order capacitor circuit is set as a=1.5, and the input voltage vᵢₙ=Vᵢₙ sin 2πft is still taken, where Vᵢₙ=1V, an AC current with f=10 kHz used for demonstrating this model, and the remaining circuit's parameters are invariable.

A simulation waveform of the circuit is shown in FIG. 5. A simulation result in FIG. 5 shows that the current peak is 1 A, with the current leading the voltage by (37.5×10⁻⁶)×10000×360°=135°=0.75π, which is consistent with a theoretical analysis result.

It should be noted that the above embodiments are only used to illustrate the technical solution of the present invention and are not for limitation. Although the present invention is described in detail with reference to the preferred embodiments, those of ordinary skill in the art should understand that the technical solutions of the present invention may be modified or replaced by equivalents without departing from the spirit and scope of the technical solutions of the present invention, and all those modifications or replacements should be included in the scope of the claims of the present invention.

One skilled in the art should understand that the embodiments of the present application may be embodied as a method, a system, or a computer program product. Accordingly, the present application may take the form of an entirely hardware embodiment, an entirely software embodiment, or an embodiment combining software and hardware aspects. Furthermore, the present application can be in the form of a computer program product implemented on one or more computer-available storage media (including, but not limited to, a magnetic disk storage, a CD-ROM, an optical memory, and the like) in which computer-available program codes are contained. The solutions in the embodiments of the present application can be implemented in various computer languages, such as object-oriented programming language Java and interpreted scripting language JavaScript, among other.

The present application is described with reference to flowcharts and/or block diagrams of the method, the device (system) and the computer program product according to the embodiments of the present application. It should be understood that each flow and/or block in the flow charts and/or the block diagrams and the combination of flows and/or blocks in the flow charts and/or the block diagrams may be realized by computer program instructions. These computer program instructions may be provided to a processor of a general purpose computer, a special purpose computer, an embedded processor, or other programmable data processing devices to generate a machine such that the instructions are executed by the processor of the computer or other programmable data processing devices to implement the functions specified in one or more flows in the flow charts and/or one or more blocks in the block diagrams.

These computer program instructions may also be stored in a computer-readable memory that can guide a computer or other programmable data processing device to work in a specific manner, so that the instructions stored in the computer-readable memory generate a product including an instruction device, where the instruction device implements functions specified in one or more flows in the flowcharts and/or one or more blocks in the block diagrams.

These computer program instructions may also be loaded onto the computer or another programmable data processing devices, so that a series of operations and steps are performed on the computer or the another programmable devices, to generate computer-implemented processing, thereby providing the functions specified in one or more flows in the flowcharts and/or one or more blocks in the block diagrams.

Although the preferential embodiments of the present application have been described, those skilled in the art may make additional changes and modifications to these embodiments once they learn the basic inventive concept. Therefore, it is intended that the appended claims are to be interpreted to include the preferred embodiments and all alterations and modifications that fall within the scope of the present application.

It will be apparent to those skilled in the art that various modifications and variations may be made to the present application without departing from the spirit and scope of the present application. Thus, it is intended that the present application covers such modifications and variations which come within the scope of the appended claims and their equivalents, as well.

What is claimed is:

1. An adjustable-order fractional-order capacitor circuit, comprising: resistor R, a fractional-order differential circuit, a feedback tracking circuit, and a subtractor circuit, wherein
an input terminal of the adjustable-order fractional-order capacitor circuit is connected to the ground at one end and to one terminal of resistor R at the other end, and the other terminal of resistor R is connected to an output terminal of the subtractor circuit;
the fractional-order differential circuit employs a junction field-effect transistor operating in a variable-resistance region to replace a fixed-value resistor in a common differential circuit, thereby achieving a differential operation;
an output of the feedback tracking circuit is applied to a gate terminal of the junction field-effect transistor in the fractional-order differential circuit, with a source terminal of the junction field-effect transistor grounded; the feedback tracking circuit controls an equivalent resistance value of the junction field-effect transistor in real time by controlling a gate-source voltage of the JFET, thereby achieving a fractional-order differential operation corresponding to a fractional order; by setting a digital reference comparison signal of a phase detector in the feedback tracking circuit, an expected fractional order is obtained; and
a voltage difference between an input voltage and an output voltage of the fractional-order differential circuit controls a voltage across resistor R, thereby controlling an input current across resistor R.

2. The adjustable-order fractional-order capacitor circuit according to claim 1, wherein the fractional-order differential circuit comprises operational amplifier opa1, resistor R₁, resistor R₂, resistor R₃, resistor R₄, capacitor C₁, and a junction field-effect transistor (JFET), wherein the JFET operates in the variable-resistance region and is equivalent to a variable resistor R_{eq};
in a complex frequency domain, let \dot{v}ᵢₙ and \dot{i}ᵢₙ denote as an input voltage and an input current of the fractional-order capacitor circuit respectively,
then \dot{v}ᵢₙ and \dot{i}ᵢₙ satisfy the following characteristics of a fractional-order capacitor:
$${\dot{i}}_{in} = {C}_{α} {s}^{α} {\dot{v}}_{in}$$
wherein s=jω represents a complex frequency, Cₐ is the fractional-order capacitance, and a is an order of the fractional-order capacitor, satisfying 0≤a≤2;
in the complex frequency domain, a voltage at a non-inverting input terminal of operational amplifier opa1 is denoted as \dot{v}₁₊, and a voltage at an inverting input terminal is denoted as \dot{v}₁₋; assuming that an input current of operational amplifier opa1 is equal to zero, the voltages at the non-inverting and inverting input terminals of operational amplifier opa1 in the fractional-order operational circuit are expressed as follows:
$${\dot{v}}_{1 +} = \frac{j ω {R}_{eq} {C}_{1}}{1 + j ω {R}_{eq} {C}_{1}} {\dot{v}}_{in}$$
$${\dot{v}}_{1 -} = \frac{{R}_{2} {\dot{v}}_{in} + {R}_{1} {\dot{v}}_{a}}{{R}_{1} + {R}_{2}}$$
and assuming that a differential input voltage of operational amplifier opa1 is equal to zero, and R₁=R₂, then the following equation is obtained:
$$\frac{{\dot{v}}_{a}}{{\dot{v}}_{in}} = a + bj = \frac{{ω}^{2} {R}_{eq}^{2} {C}_{1}^{2} - 1 + j 2 ω {R}_{eq} {C}_{1}}{1 + {ω}^{2} {R}_{3}^{2} {C}_{1}^{2}}$$
$$a = \frac{ω {R}_{eq}^{2} {C}_{1}^{2} - 1}{1 + {ω}^{2} {R}_{eq}^{2} {C}_{1}^{2}}$$
$$b = \frac{2 ω {R}_{eq} {C}_{1}}{1 + {ω}^{2} {R}_{eq}^{2} {C}_{1}^{2}}$$
wherein R_{eq} represents an equivalent resistance value of the junction field-effect transistor (JFET), \dot{v}ₐ represents an output voltage of the fractional-order differential circuit, \dot{v}ᵢₙ represents an input voltage of the fractional-order differential circuit, C₁ represents a capacitance value, a is a real part, and b is an imaginary part.

3. The adjustable-order fractional-order capacitor circuit according to claim 2, wherein the fractional-order differential circuit further comprises:
assuming that the output voltage \dot{v}ₐ and an input voltage \dot{v}ᵢₙ of the fractional-order differential circuit satisfy the following fractional-order differential relationship:
$${\dot{v}}_{a} = {kj}^{α} {\dot{v}}_{in} = k {\dot{v}}_{in} ( cos \frac{απ}{2} + j sin \frac{απ}{2} )$$
wherein a coefficient k is a gain of the fractional-order differential circuit, a is a fractional order, and 0<a<2 in the fractional-order capacitor circuit;
the following result is obtained according to a correspondence between the real part and the imaginary part:
$$\frac{2 ω {R}_{eq} {C}_{1}}{ω {R}_{eq}^{2} {C}_{1}^{2} - 1} = tan \frac{απ}{2}$$
wherein the output voltage \dot{v}ₐ of the fractional-order differential circuit leads the input voltage \dot{v}ᵢₙ of the fractional-order differential circuit in a phase by aπ/2.

4. The adjustable-order fractional-order capacitor circuit according to claim 3, wherein the fractional-order differential circuit further comprises:
additional resistors R₃ and R₄ are introduced in the circuit to reduce nonlinearity of an equivalent resistance of the JFET by means of circuit compensation, and an output current i_{D} of the JFET is related to a gate-source voltage v_{GS} and a drain-source voltage v_{DS} as follows:
$${i}_{D} = K ( {v}_{GS} - {v}_{T} - \frac{{v}_{DS}}{2} ) {v}_{DS}$$
wherein K is a constant corresponding to each field-effect transistor, v_{T} is an approximate threshold voltage, and the equivalent resistance R_{DS} of the JFET is:
$${R}_{DS} = \frac{\partial {i}_{D}}{\partial {v}_{DS}} = \frac{1}{K ( {v}_{GS} - {v}_{T} - \frac{{v}_{DS}}{2} )}$$
wherein a value of the equivalent resistance R_{DS} of the JFET is equal to that pf a variable resistance R_{eq}, i.e., R_{DS}=R_{eq}.

5. The adjustable-order fractional-order capacitor circuit according to claim 4, wherein the fractional-order differential circuit further comprises:
resistors R₃ and R₄ are used to suppress an effect of v_{DS} on i_{D} through negative feedback of v_{DS}, and the gate-source voltage v_{GS} of the JFET satisfies the following relationship with a feedback voltage v_{fd} and drain-source voltage v_{DS}:
$${v}_{GS} = \frac{{R}_{4} {v}_{fd}}{{R}_{3} + {R}_{4}} + \frac{{R}_{3} {v}_{DS}}{{R}_{3} + {R}_{4}}$$
assuming that values of resistances satisfies R₃=R₄, the following equation is derived:
$${v}_{GS} = \frac{{v}_{fd}}{2} + \frac{{v}_{DS}}{2}$$
and the following equation is obtained according to an expression of the equivalent resistance of the JFET:
$${i}_{D} = K [ {v}_{GS} - {v}_{T} - \frac{{v}_{DS}}{2} ] {v}_{DS} = K ( \frac{{v}_{fd}}{2} - {v}_{T} ) {v}_{DS}$$
$${R}_{DS} = \frac{\partial {i}_{D}}{\partial {v}_{DS}} = \frac{1}{K ( \frac{{v}_{fd}}{2} - {v}_{T} )}$$
wherein K is the constant corresponding to each field-effect transistor, and v_{T} is the approximate threshold voltage.

6. The adjustable-order fractional-order capacitor circuit according to claim 5, wherein the feedback tracking circuit comprises: a phase detector, an RC low-pass filter, an integrator, and a voltage follower, wherein
the phase detector comprises a multiplier and a subtractor;
the RC low-pass filter consists of capacitor C₂ and resistor R₉;
the integrator consists of operational amplifier opa2, resistor R₁₀, resistor R₁₁, and capacitor C₃; and
the voltage follower consists of operational amplifier opa3, resistor R₁₂, and resistor R₁₃.

7. The adjustable-order fractional-order capacitor circuit according to claim 6, the subtractor circuit comprises: operational amplifier opa4, resistor R₅, resistor R₆, resistor R₇, and resistor R₈, wherein
in the complex frequency domain, a voltage at a non-inverting input terminal of operational amplifier opa4 is \dot{v}₂₊, and a voltage at an inverting input terminal is \dot{v}₂₋; assuming that an input current of operational amplifier opa4 is equal to zero, the following equation is obtained:
$${\dot{v}}_{2 +} = \frac{{R}_{8}}{{R}_{7} + {R}_{8}} {\dot{v}}_{in}$$
$${\dot{v}}_{2 -} = \frac{{R}_{5} {\dot{v}}_{o} + {R}_{6} {\dot{v}}_{a}}{{R}_{5} + {R}_{6}}$$
assuming that a differential input voltage of operational amplifier opa4 is equal to zero, and R₅=R₆=R₇=R₈, then the following equation is obtained:
$${\dot{v}}_{o} = {\dot{v}}_{a} - {\dot{v}}_{in}$$
an output voltage of the subtractor is given by the following equation:
$${\dot{v}}_{o} = {\dot{v}}_{in} - \frac{1}{{ω}^{α}} {( j ω )}^{α} {\dot{v}}_{in}$$
according to Kirchhoff s voltage law, the voltage across resistor R is:
$${\dot{v}}_{R} = {\dot{v}}_{in} - ( {\dot{v}}_{in} - \frac{1}{{ω}^{α}} {( j ω )}^{α} {\dot{v}}_{in} ) = \frac{1}{{ω}^{α}} {( j ω )}^{α} {\dot{v}}_{in}$$
and then a current flowing through resistor R, i.e., the input current, is:
$${\dot{i}}_{in} = \frac{1}{{ω}^{α} R} {( j ω )}^{α} {\dot{v}}_{in} = {C}_{α} {s}^{α} {\dot{v}}_{in}$$
wherein a capacitance value of the fractional-order capacitor is C_{α}=1/ω^{α}R, and \dot{v}ₒ represents an output voltage of the subtractor.

8. A method for controlling an adjustable-order fractional-order capacitor circuit, comprising:
setting an order of the fractional-order capacitor circuit as required by a system, and designing a set circuit consisting of a resistor, a fractional-order differential circuit, a feedback tracking circuit, and a subtractor circuit according to the order of the fractional-order capacitor circuit;
using the fractional-order differential circuit for a differentiation operation, applying an output of the feedback tracking circuit to the fractional-order differential circuit, achieving a fractional-order differentiation operation by the feedback tracking circuit controlling an internal voltage, and obtaining an expected fractional order by setting a digital reference comparison signal of a phase detector in the feedback tracking circuit; and
controlling an input current across the adjustable-order fractional-order capacitor circuit by controlling a voltage across resistor R according to a voltage difference between an input voltage and an output voltage of the fractional-order differential circuit.

9. A computer device, comprising a memory in which a computer program is stored and a processor, wherein when the computer program is executed by the processor, the steps of the method according to claim 8 are implemented.

10. A computer-readable storage medium in which a computer program is stored, wherein when the computer program is executed by a processor, the steps of the method according to claim 8 are implemented.
